(19) United States
(12) Patent Application Publication
(10) Pub. No.: US 2001/0049014 A1
(43) Pub. Date: Dec. 6, 2001

(54) Multilayer film laminates

(76) Inventors: Sven Jacobsen, Fallingbostel (DE); Christian Kuckertz, Olpe (DE); Rainer Brandt, Walsrode (DE)

Correspondence Address: BAYER CORPORATION, PATENT DEPARTMENT, 100 BAYER ROAD, PITTSBURGH, PA, 15205, US

(21) Appl. No.: 09/855,064

(22) Filed: May 14, 2001

(30) Foreign Application Priority Data
May 22, 2000 (DE) 10025305.9

(51) Int. Cl. B32B 3/00; B32B 27/40; B32B 27/08

(52) U.S. Cl. 428/336; 428/425.5; 428/451; 428/203

(57) ABSTRACT

Described is a multilayer film laminate comprising the following sequence of three layers: (I) a first film layer with a vapor deposited coating selected from the group consisting of aluminum, SiOx, and a metal oxide of main group 2 or 3 of the periodic table of the elements, the vapor deposited coating being located on one side of the first film layer; (II) a second film layer with a vapor deposited coating selected from the group consisting of aluminum, SiOx, and a metal oxide of main group 2 or 3 of the periodic table of the elements, the vapor deposited coating being located on both sides of the second film layer; and (III) a heat sealing layer. Also described is a method of using the multilayer film laminate as a barrier film in vacuum insulation panels.

### FIELD OF THE INVENTION

The present invention relates to film laminates which, as high barrier films, are particularly impermeable to gas diffusion and to the use of these gas diffusion impermeable film laminates in the production of vacuum insulation panels.

### BACKGROUND OF THE INVENTION

In some specific industrial products, such as for example in the production of vacuum insulation panels (VIP), there is a requirement for films which have extremely low gas diffusion values, in order to ensure that once applied, the vacuum and thus the effectiveness of the VIPs are retained over a very long period of time (e.g., 10-15 years).

As used herein and in the claims, the term “vacuum insulation panels (VIPs)” means sheet-like structures which include an insulating material or packing, that are vacuum packed in a high barrier film envelope. The level of the vacuum are here determined by the insulating material or packing used and the required insulation action of the VIP. Over the service life of the VIP, the high barrier film prevents the diffusion of gases which impair or deplete the vacuum and thus the insulating properties of the VIP. Metal foils are undesirable as high barrier films as they conduct heat around the edges of the sheet-form VIP, so reducing insulation performance. Conventional barrier layer films made from plastics, as described for example in EP-A 0 517 026, do not achieve the necessary gas barrier action. While composites which contain aluminium foil do indeed provide a complete gas barrier, they are undesirable in many applications due to the thermal conductivity of the aluminium. Metallised films or films with a vapor deposited SiOx coating are furthermore known which avoid the disadvantages with regard to the thermal conductivity of pure metal foils (for example, as described in EP-A 0 878 298) and simultaneously achieve higher levels of barrier action than do pure plastics films. However, the levels of barrier action obtained with films having vapor deposited SiOx coatings are still far below the required gas barrier values.

### SUMMARY OF THE INVENTION

The object of the present invention is accordingly to provide film laminates which achieve particularly elevated gas barrier action without using thermally conductive metal foils as a component. It is simultaneously intended to have a positive influence upon further mechanical and thermal properties of the film laminate by means of a suitable combination of materials. In particular, the intention is to provide film laminates which are suitable for the production of vacuum insulation panels (VIP).

In accordance with the present invention, there is provided a multilayer film laminate comprising at least the following sequence of three layers:

(I) a first plastic film layer with a vapor deposited coating selected from the group consisting of aluminum, SiOx, and a metal oxide of main group 2 or 3 of the periodic table of the elements, said vapor deposited coating being located on one side of said first film layer;

(II) a second plastic film layer with a vapor deposited coating selected from the group consisting of aluminum, SiOx, and a metal oxide of main group 2 or 3 of the periodic table of the elements, said vapor deposited coating being located on both sides of said second film layer; and

(III) a heat sealing layer.

As used herein and in the claims, the term “SiOx” means silicon oxide, having x oxygen atoms, e.g., from 2 to n oxygen atoms.

As used herein and in the claims the phrase “main group 2 or 3 of the periodic table of the elements” is meant to be inclusive of the elements Be, Mg, Ca, Sr, Ba, Al, Ga, In, TI.

Unless otherwise indicated, all numbers expressing quantities of ingredients, reaction conditions, etc. used in the specification and claims are to be under stood as modified in all instance by the term “about.”

### DETAILED DESCRIPTION OF THE INVENTION

The initial expectation in this connection would be that gas barrier action is determined by the gas barrier action of the best of the individual layers or is calculated as the sum of the barrier actions of the individual layers, but, surprisingly, levels of gas barrier action are obtained which are not only distinctly higher than those of the individual layers but are in part distinctly higher than the sum of the individual layers. While not intending to be bound by any theory, this may, for example, be explained by supplementary (synergistic) coverage of defects in the individual metallised layers, which lie upon each other when the various film layers, or plies, (I) and (II) are laminated.

The vapor deposited coatings of film layers (I) and (II) of the multilayer film laminate of the present invention may be applied by art recognized methods.

In order to achieve still higher gas diffusion barrier values, further film layers (e.g., further first and/or second film layers Ia, Ib, IIa, IIb, etc.) may optionally be inserted (or interposed) between the layers (II) and (III), and/or between the layers (I) and (II). These additional film layers are selected from the group consisting of: a film layer having on one or both sides a vapor deposited coating selected from the group consisting of aluminum, SiOx, and a metal oxide of main group 2 or 3 of the periodic table of the elements; a gas barrier layer that is free of vapor deposited coatings; and a layer that is free of vapor deposited coatings.

The polymer of the layers having a vapor deposited coating of aluminium or SiOx or a metal oxide of main group 2 or 3 of the periodic table of the elements (i.e., film layers (I) and (II)) may include any of the known conventional plastics, preferred examples of which include, but are not limited to polyesters, polyamides, polyolefins or the copolymers thereof. These layers may furthermore also be composed of coextruded plies of different polymers. The thickness of the individual layers is not essential in this connection, but will, to a small extent, influence gas barrier action and, furthermore, contribute to the mechanical and thermal properties of the film laminate.

With the multilayer film laminates according to the present invention, it is in particular possible to achieve oxygen diffusion values of less than 0.01 cm³/m² d bar (determined at a temperature of 23° C., and at 75% relative humidity) and water vapor diffusion values of less than 0.1 g/m² d (determined at a temperature of 38° C., and at 90% relative humidity). When the multilayer film laminates are produced with more than 3 layers, it is entirely possible also to obtain film laminates which achieve distinctly lower gas diffusion values still. By means of the combination of the various plies, it is not only possible to adjust the gas diffusion values to the values required by the application, but it is also possible to vary the mechanical and/or thermal characteristics of the resultant multilayer film laminate according to the invention. Such a modification of the mechanical and/or thermal characteristics of the resultant multilayer film laminate of the present invention can be achieved by modifying the layer material which is provided with a vapor deposited coating of aluminium or SiOx or a metal oxide of main groups 2 or 3 of the periodic table of the elements.

A polyamide layer with a vapor deposited coating of aluminium or SiOx or a metal oxide of main group 2 or 3 is preferably selected as the external first layer (I); the resultant film laminate is distinguished, in addition to the good gas diffusion barrier values, by elevated mechanical stability, in particular by elevated puncture resistance, which offers advantages in handling the film laminates according to the invention, thus preventing damage to the laminates and VIPs produced therefrom. Such VIPs must at times withstand considerable mechanical loads both during manufacture and during installation in the final application, which may result in damage to the film and thus impaired barrier properties.

In another preferred embodiment of the present invention, a polypropylene layer with a vapor deposited coating of aluminium or SiOx or a metal oxide of group 2 or 3, which is distinguished by particularly good water vapor barrier action, is selected as the external first layer (I). If this external layer is then combined with a subsequent second layer (II) which is composed of a polyester with a vapor deposited coating on both sides of aluminium or SiOx or a metal oxide of main group 2 or 3, which is in turn distinguished by particularly good oxygen barrier action, the resultant film laminate according to the present invention will be distinguished both by better water vapor barrier action in comparison with the polypropylene layer alone, and by better oxygen barrier action in comparison with the polyester layer alone. In this particular embodiment, the crucial oxygen and water vapor barrier elements not only complement but synergistically support each other in a particularly convincing manner.

In another embodiment of the present invention, one or more of the layers (I, II) with a vapor deposited coating of aluminum or SiOx or a metal oxide of main group 2 or 3 is/are a coextruded layer, in which this coextruded layer is produced from at least one ply of polyamide (a), and at least one gas barrier ply (b). One particularly desirable structure is a 3-ply combination of polyamide in the outer layers and a copolymer of ethylene/vinyl alcohol (EVOH) as a gas barrier layer in the inner ply. In the resultant multilayer film laminate according to the present invention, the gas barrier ply provides extremely improved gas barrier values, and, in particular, improved oxygen barrier values when EVOH is used as the gas barrier ply.

In one particularly preferred embodiment of the present invention, one or more of the layers (I, II) is/are provided with a vapor deposited coating of aluminium, preferably having a thickness of 30 to 80 nm.

Polyolefin homo- or polyolefin copolymers may be used as the heat sealing layer (III). Examples of polyolefin homo- or polyolefin copolymers that may be used as the heat sealing layer (III) include, but are not limited to: linear low density polyethylene (LLDPE); polybutylene (PB); ethylene/vinyl acetate (EVA); polypropylene (PP); high density polyethylene (HDPE); ionomer polymers (IO); and mixtures of these substances are preferred, while amorphous polyethylene terephthalate (aPET) or other heat sealable polymer materials may also be considered. A multilayer embodiment of the heat sealing layer (III) produced by coextruding two or more layers of the stated materials is also possible according to the invention. The thickness of the heat sealing layer (III) is preferably 20 to 200 μm, particularly preferably 50 to 100 μm.

In particular, ionomer sealing layers or other easy flowing sealing (sealing layers having a high MFI) which give rise to particularly gas-tight seams under the dusty conditions typical in VIP production, are used as the heat sealing layer (III) when the multilayer film laminates of the present invention are used in the production of VIPs.

Conventional commercially available reactive adhesives, such as in particular two component polyurethane adhesives, may be used as the adhesive and bonding layer between the individual layers of the multilayer film laminates of the present invention. It is, however, also possible to use polyolefin coupling agents, preferably polyethylene homopolymer, ethylene/ethyl acrylate (EEA) or ethylene/methacrylic acid (EMA) as an adhesive or bonding layer between the individual layers of the multilayer film laminate. However, the multilayer film laminate according to the invention, and in particular the gas barrier action thereof, does not essentially depend upon the nature of the bond between the individual layers.

Particularly in the case of two component polyurethane adhesives, care must typically be taken to ensure that the composition of the components is selected such that the least possible evolution of gas occurs. Otherwise, gas bubbles may, undesirably, form in the bonding layers.

The film laminate according to the present invention may have printing (e.g., printed indicia, such as lettering, and/or bar codes) on the external side, e.g., on external first layer (I).

In a further embodiment of the present invention, the external first layer (I) is not provided with a vapor deposited coating, but is instead printed on the inner side, such that said printed image is visible from the outside.

The present invention also provides a method of using the multilayer film laminates according to the invention as barrier films, and in particular high barrier films, in vacuum insulation panels.

Embodiments of multilayer film laminates according to the present invention are represented by the following sequential structures (A) through (H). These representative sequential multilayer film laminate structures are not intended to be restrictive of the scope of the present invention.

(A)

(I) polyamide with a vapor deposited coating of aluminium, coated side facing towards (II)

(II) polyester with a vapor deposited coating of aluminium on both sides

(III) polyethylene sealing layer

(B)

(I) polyester with a vapor deposited coating of aluminium, coated side facing towards (II)

(II) polyester with a vapor deposited coating of aluminium on both sides

(III) polyethylene sealing layer

(C)

(I) polypropylene with a vapor deposited coating of aluminium, coated side facing towards (II)

(II) polyester with a vapor deposited coating of aluminium on both sides

(III) polyethylene sealing layer

(D)

(I) polyamide with a vapor deposited coating of aluminium, coated side facing towards (II)

(II) polypropylene with a vapor deposited coating of aluminium on both sides

(III) ionomer sealing layer

(E)

(I) polyamide/EVOH/polyamide 3-layer coextrudate with vapor deposited coating of aluminium, coated side facing towards (II)

(II) polyester with a vapor deposited coating of aluminium on both sides

(IIa) polyester with a vapor deposited coating of aluminium on both sides

(III) amorphous polyethylene terephthalate sealing layer

(F)

(I) polyamide with a vapor deposited coating of aluminium, coated side facing towards (II)

(II) polyester with a vapor deposited coating of aluminium on both sides

(IIa) polyester with a vapor deposited coating of aluminium on both sides

(IIb) polyester with a vapor deposited coating of aluminium on both sides

(III) polypropylene sealing layer

(G)

(I) polyamide with vapor deposited coating of SiOx, coated side facing towards (II)

(II) polyester with a vapor deposited coating of SiOx on both sides

(III) ionomer sealing layer

(H)

(I) polypropylene with vapor deposited coating of SiOx, coated side facing towards (II)

(II) polyester with a vapor deposited coating of aluminium on both sides

(III) polyethylene sealing layer

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A multilayer film laminate comprising the following sequence of three layers:
(I) a first film layer with a vapor deposited coating selected from the group consisting of aluminum, SiOx, and a metal oxide of main group 2 or 3 of the periodic table of the elements, said vapor deposited coating being located on one side of said first film layer;
(II) a second film layer with a vapor deposited coating selected from the group consisting of aluminum, SiOx, and a metal oxide of main group 2 or 3 of the periodic table of the elements, said vapor deposited coating being located on both sides of said second film layer; and
(III) a heat sealing layer.

2. The multilayer film laminate of claim 1, further comprising at least one additional layer selected from the group consisting of: a film layer having on one or both sides a vapor deposited coating selected from the group consisting of aluminum, SiOx, and a metal oxide of main group 2 or 3 of the periodic table of the elements; a gas barrier layer that is free of vapor deposited coatings; and a functional layer that is free of vapor deposited coatings, wherein said additional layer is interposed between the layers (II) and (III), or between the layers (I) and (II).

3. The multilayer film laminate of claim 1 wherein said first film layer (I) is an external layer, and said vapor deposited coating of said first film layer (I) is interposed between said first film layer (I) and the vapor deposited coating of said second film layer (II).

4. The multilayer film laminate of claim 1 wherein said first layer (I) is an external polyamide layer.

5. The multilayer film laminate of claim 1 wherein said first layer (I) is an external polypropylene layer.

6. The multilayer film laminate of claim 1 wherein at least one of the layers (I) and (II) is a coextruded layer, the coextruded layer being produced from at least one ply of polyamide (a), and at least one gas barrier ply (b).

7. The multilayer film laminate of claim 6 wherein said gas barrier ply (b) is an EVOH ply.

8. The multilayer film laminate of claim 1 wherein the individual layers of said multilayer film laminate are laminated by means of two component polyurethane adhesives, the ratio of the adhesive components being selected such as to minimize the quantities of gas liberated during curing of the two component polyurethane adhesive.

9. The multilayer film laminate of claim 1 wherein the layers (I) and (II) each have a vapor deposited coating of aluminum, having a thickness of 30 to 80 nm.

10. The multilayer film laminate of claim 1 wherein the first layer (I) is an external layer having printing thereon.

11. A method of using the multilayer film laminate of claim 1 as a barrier film in vacuum insulation panels.

12. A multilayer film laminate comprising the following sequence of three layers:
(i) a first film layer, printed on the inner side such that said printed image is visible from the outside;
(ii) a second film layer with a vapor deposited coating selected from the group consisting of aluminum, SiOx, and a metal oxide of main group 2 or 3 of the periodic table of the elements, said vapor deposited coating being located on both sides of said second film layer; and
(iii) a heat sealing layer.
